(19) United States
(12) Patent Application Publication
(10) Pub. No.: US 2004/0056961 A1
(43) Pub. Date: Mar. 25, 2004

(54) Single-hand held camera usable in narrow space

(76) Inventor: Kenzo Ito, Munakata City (JP)

Correspondence Address: ROSENBERG, KLEIN & LEE, 3458 ELLICOTT CENTER DRIVE-SUITE 101, ELLICOTT CITY, MD, 21043, US

(21) Appl. No.: 10/252,706

(22) Filed: Sep. 24, 2002

(51) Int. Cl. H04N 5/225

(52) U.S. Cl. 348/207.99

(57) ABSTRACT

A single hand held camera with a monitor for use in narrow space includes a main body, a photographing member, a head member, and a handle. The main body has a monitor for image of a subject to be displayed thereon. The head member extends from the main body to be opposite the head member for allowing light from a subject to traveling through to be received by the photographing member. The handle is equipped with a button, which is to be pressed with the user's index finger for recording image of the subject in a memory. The camera can be used in dental practice, in which occasion the practitioner can always observe inside of the patient's oral cavity through the monitor, not having to move his head away from the monitor while adjusting orientation of the head member.

### BACKGROUND OF THE INVENTION

1. Field of the Invention

The present invention relates to a single hand held camera having a monitor and usable in narrow space, more particularly a camera, which has a monitor, and is operable with one hand to take pictures in a narrow space.

2. Brief Description of the Prior Art

Video cameras, TV, and digital cameras are greatly relied on by medical practitioners to observe inside of patients' body parts having narrow spaces in their medical practice. And, photos are taken with the cameras for helping diagnose, helping explanation to the patients, and future use. For example, it is a common practice that dentists insert the imaging heads of cameras for narrow spaces into the patients' mouth, and observe images on the monitoring members of the cameras.

Conventional cameras provided for dentists' use usually have a cylindrical head member, and a monitoring system positioned away from the head member. The head member has a handle portion extending opposite to the head lens thereof. The cameras can be equipped with wireless means for transmitting image data from the head member to the monitoring system, which can be CRT (cathode ray tube) monitors, and are usually relatively big in size. The cameras can also be instead equipped with signal cables for transmitting image data. The head member has a narrow front end to be inserted into a patient's mouth, and has a photographing system therein. The monitoring system is positioned as near to the dental practitioners as possible.

In using such dental cameras, if there is only one dental practitioner, the dental practitioner first has to adjust the orientation of the head member in relation to the inside of the patient's mouth, and then look at the images on the monitoring system because the monitoring system is positioned at a distance from the head member. Consequently, the dental practitioner has to move his face from the head member to the monitoring system, and vice versa over and over again to check whether he has adjust the head member to the desired position. When the image on the monitoring system shows the desired position, the dental practitioner can have the image recorded or printed by means of pressing related control buttons or control pedals.

If there are two dental practitioners to operate such dental cameras, one of the dental practitioners has to hold the head member in the patient's mouth, and the other looks at the images on the monitoring system at the same time, and have desired images recorded or printed.

From the above description, it can be easily understood that the conventional camera used for dental practice is not convenient to use because a dental practitioner has to move his face from the head member to the monitoring system, and vice versa over and over again to check whether the head member is in the right portion, and then operate the related buttons or pedals to record or print the images, costing him a lot of labor. Consequently, another dental practitioner is need resulting in increase of cost. Furthermore, such dental cameras cannot be moved around easily because the monitoring system is relatively big in size, not very convenient to use.

### SUMMARY OF THE INVENTION

It is a main object of the present invention to provide a camera for taking images in a narrow space, which is portable, and equipped with a monitoring member.

The single hand held camera with a monitor for use in narrow space according to the present invention includes a main body, a photographing member, a head member, and a handle. The main body has a monitor for image of a subject to be displayed thereon. The head member extends from the main body to be opposite the head member for allowing light from a subject to traveling through to be received by the photographing member. The handle is joined to the main body for allowing a user to hold in operating the camera.

The handle of the present camera has a battery disposed therein, and a memory chip inserted therein, and is equipped with a button on a same side of the head member for effecting recording of image of a subject with the memory chip, and a control panel on a same side of the monitor, which is provided with a power switch, an indicator lamp, a stand-by switch, and forward and reverse play buttons operable for replaying images recorded in the memory chip on the monitor.

The head member has white light emitting diodes disposed therein for providing light to subjects to be photographed, and the photographing member is preferably a digital camera, provided for photographing image of the subject, and the monitor is a TFT colorful display device, provided for displaying image of the subject on.

The head member is preferably 0.8 to 2.5 centimeters in diameter, and 1 to 15 centimeters in length, and the digital camera has a fixed focus lens made in such a manner as to allow subjects to be photographed over a long range, and the monitor is 2.5″ to 3.5″ in size, and the camera is under 1 kg in weight.

The present camera can be operated by a single dental practitioner, which holds the handle with his/her right hand, and inserts the head member into the oral cavity of a patient. Because the monitoring member is disposed behind the head member so that the dental practitioner can look at the same easily while he is adjusting orientation of the head member in relation to the subjects in the patient's oral cavity. Therefore, the user can always observe inside of the patient's oral cavity through the monitor, not having to move his/her head away from the monitor while adjusting orientation of the head member.

A dental mirror is used with the dental practitioner's left hand in case the front end of the head member cannot be directed at the subject position to be photographed. The dental mirror is faced with the subject to be photographed in the oral cavity, and the front end of the head member is directed at the dental mirror so that light from the subject is reflected to the digital camera by the mirror, and image of the subject is displayed on the monitor. Since dentists, based on their training, can operate a dental drill in a patient's oral cavity with the right hand, and at the same time a dental mirror with the left hand skillfully, they can use the present camera with one hand easily while they are using a dental mirror with the other hand.

The button is positioned such that a dental practitioner can press the same easily for recording the image with the index finger of the right hand while he is holding the handle with the right hand. This action is as easy as pulling the trigger of a gun.

The image shown on the monitor will be made recorded in the memory chip electronically by a control circuit when the button is pressed. At the same time, time of the image being recorded and a serial number are also recorded in the memory chip together with the image.

If the button is not pressed to record the image for a predetermined length of time, the control circuit will cut off the white LCD for effecting stand-by mode of the camera so that power can be saved. When the button is pressed under the stand-by mode, the white LCD will be electrified to emit light again for the camera to turn to the recording mode. Thus, when the button is pressed one more time, the image will be recorded in the memory chip.

The forward and reverse play buttons are pressed for effecting replay mode, under which the white LCD are cut off, the images recorded in the memory chip will be replayed one by one in sequence when the forward play button is pressed repeatedly, and the recorded images will be replayed one by one in reverse order when the reverse play button is pressed repeatedly.

The dental camera is compact and portable, and equipped with TFT monitor, allowing the dental practitioner to diagnose the illness or explain to the patient conveniently.

### BRIEF DESCRIPTION OF THE DRAWINGS

The present invention will be better understood by reference to the accompanying drawings, wherein

FIG. 1 is a partial cross-sectional view of the camera for taking images in a narrow space according to the present invention,

FIG. 2 is a front view of the control panel of the camera according to the present invention,

FIG. 3 is a circuit diagram the camera of the present invention; and,

FIG. 4 is a view showing the way of using the camera according to the present invention.

### DETAILED DESCRIPTION OF THE PREFERRED EMBODIMENTS

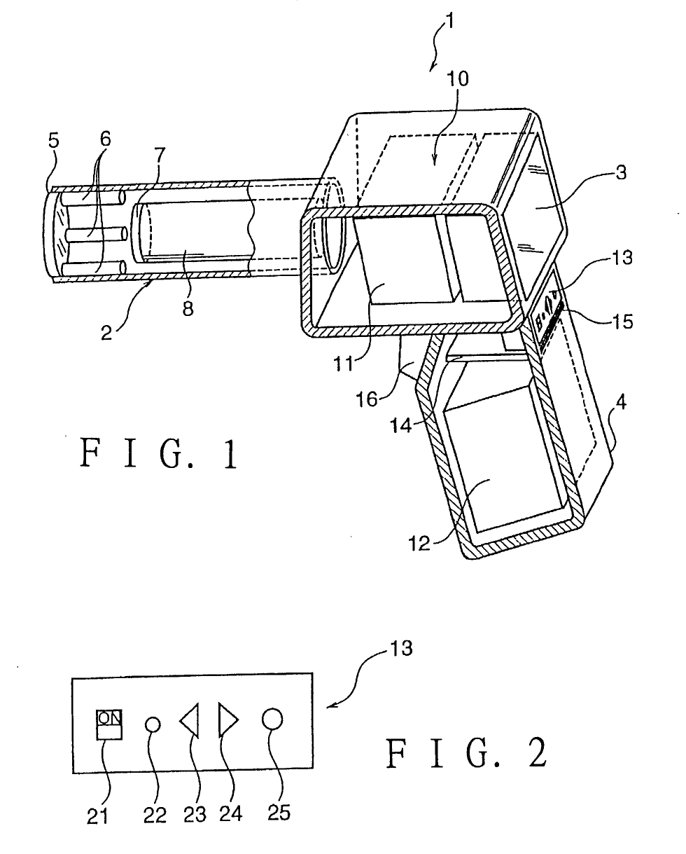

Referring to FIG. 1, a dental camera 1 according to the present invention includes a head member 2, a main body 10, a monitor 3, and a handle 4.

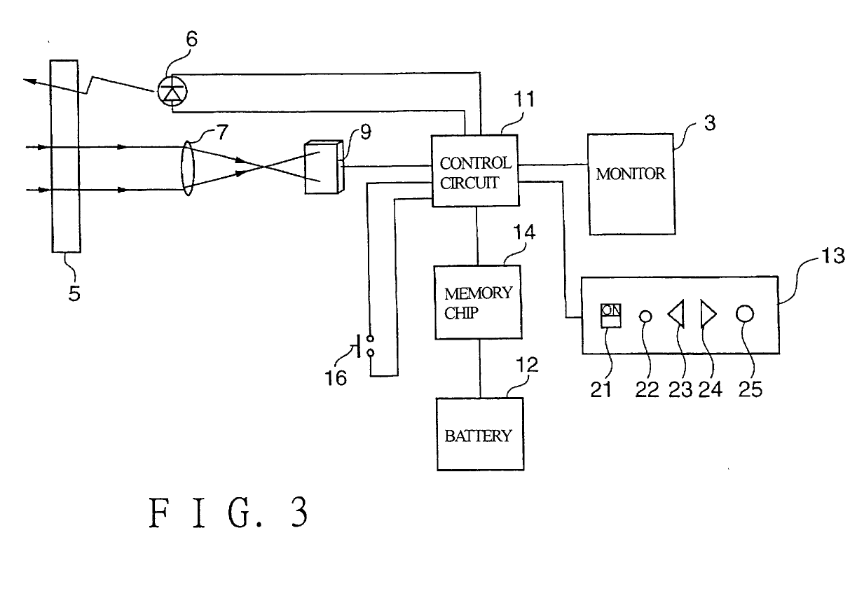

The head member 2 is cylindrical, and has a filter lens 5 disposed at a front end thereof. The head member 2 has white light emitting diodes 6, and a semiconductor photographing member 9 (FIG. 3) disposed therein, which includes a digital camera 8 having a fixed focus lens 7; the fixed focus lens 7 is made in such a manner as to allow subjects to be photographed over a long range. The head member 2 is preferably 0.8 to 2.5 centimeters in diameter, and 1 to 15 centimeters in length. The monitor is 2.5″ to 3.5″ in size.

Light from photographed subjects passes through the lens 5, and 7, and is made to become image on the semiconductor photographing member such as CCD (charged-coupled device), which has resolution of about three hundred thousand pixels on six square mm. The image taken by the semiconductor photographing member 9 is transformed into electrical signals, which are then transmitted to, and processed by, a control circuit 11 disposed in the main body 10 so that a colorful image is displayed on the monitor 3. The monitor 3 can be a colorful TFT display device. The image on the monitor 3 is about 2 to 3 times the dimension of the real subject.

The handle 4 extends from the bottom of the main body 10, and is shaped in such a manner that human can hold with one hand easily. The handle 4 has a button 16 on the front side of the upper portion, a battery 12 disposed therein, and a slot 15, which is provided for insertion of a memory chip 14 into the handle 4. An operating panel 13 is provided on the rear side of the handle 4. The battery 12 provides power to the electric devices of the dental camera. The memory chip 14 is of non volatilize form such as RAM. The button 16 is positioned so that while a user is holding the handle 4 with one of his hand, he can press the same easily with the index finger of that hand; when the button 16 is pressed, the image shown on the monitor 3 will be recorded in the memory chip 14.

Referring to FIG. 2, the operating panel 13 has a power switch 21, an indicator lamp 22, a reverse play button 23, a forward play button 24, and a stand-by switch 25 provided thereon. The indicator lamp 22 is provided for indicating on/off of the power. The images recorded in the memory chip 14 can be shown on the monitor 3 in order by means of pressing the forward play button 24, and in reverse order by means of pressing the reverse play button 23. The white light emitting diodes 6 are cut off when the stand-by switch 25 is pressed.

In using the dental camera 1, referring to FIG. 3, the power switch 21 is pressed to make power of the battery 12 provided to the electric devices; thus, the indicator lamp 22 emits light, and the white LED 6 emit light to the subjects to be photographed.

A dental practitioner holds the camera 1 at the handle 4, and inserts the head member 2 into the oral cavity of a patient, directing the front end of the head member 2 to the subjects to be photographed. Light reflected from the subjects to be photographed passes through the lens 5, and 7, and is made to become an image on the CCD (charged-coupled device) 9 having resolution of about three hundred thousand pixels on six square mm. The image taken by the CCD 9 is transformed into electrical signals, which are then transmitted to, and processed by, a control circuit 11 disposed in the main body 10 so that a colorful image about 2 to 3 times the dimension of the real subject is displayed on the monitor 3. The image shown on the monitor 3 will be made recorded in the memory chip 14 electronically by the control circuit 11 when the button 16 is pressed. At the same time, time of the image being recorded, which is presented with a drawing of a clock, and a serial number are also recorded in the memory chip 14 together with the image.

Immediately after the button 16 is pressed, “recording” will be shown on the monitor 3 on the course of the recording process. And, after the recording process is finished, the image just recorded in the memory chip 14 will be displayed on the monitor 3 for about one second for the user to confirm. Then, a new image from the subject, at which the head member 2 is directed, is shown on the monitor 3, allowing the user to record the same in the memory chip 14 by means of pressing the button 16; time of recording and the serial number for this new image are also recorded. Thus, an image is recorded each time the user presses the button 16.

If the button 16 is not pressed to record the image for a predetermined length of time, e.g. thirty seconds, the control circuit 11 will cut off the white LCD 6 for effecting stand-by mode of the camera. Therefore, power consumption can be saved. When the button 16 is pressed under the stand-by mode, the white LCD 6 will be electrified to emit light again, allowing image of a subject to be shown on the monitor 3. And, when the button 16 is pressed one more time, the image will be recorded in the memory chip 14.

The buttons 24, 25 are pressed for effecting replay mode of the present camera 1, under which the white LCD 6 are cut off, the control circuit 11 will make the images recorded in the memory chip 14 replayed one by one in sequence when the forward play button 24 is pressed repeatedly; the recorded images will be replayed one by one in reverse order when the reverse play button 23 is pressed repeatedly. While the recorded images are replayed, time of photographing and serial number of each image are also shown on the monitor 3 for allowing the viewers to refer to. If the button 16 is pressed under the replay mode, the present camera 1 will turn to the recording mode from the replay mode.

The memory chip 14 can be inserted into the handle 4, and drawn out from the same via the slot 15 to be inserted into an external large-size monitor (not shown); thus, recorded images in the memory chip 14 can be replayed on the external monitor with bigger dimensions for allowing the viewers to see the details more clearly. The memory chip 14 can also be connected to an external printer (not shown) so that the images can be printed. Time of photographing and serial number of each image are also shown on the external large size monitor or the paper of the printer.

Usage of Present Dental Camera:

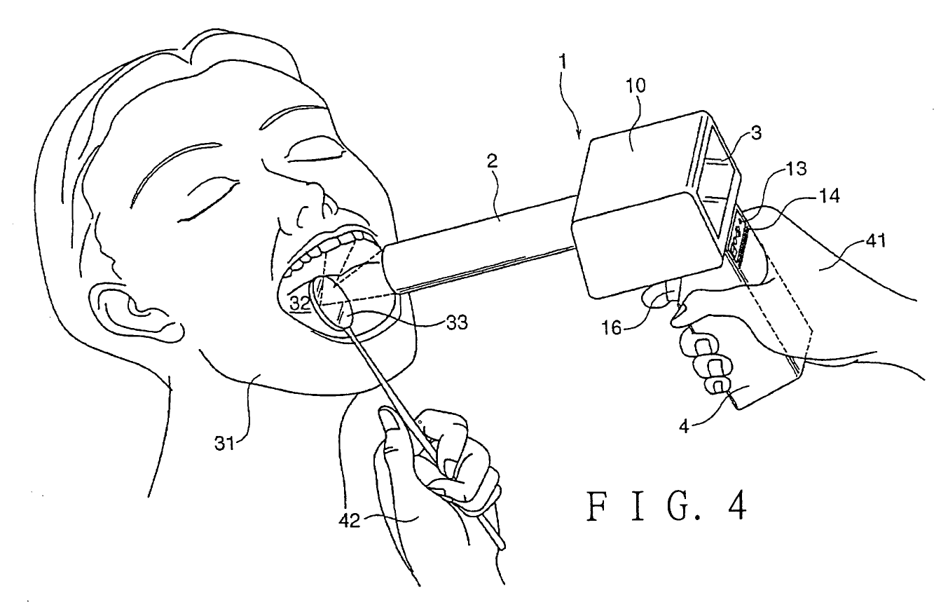

Referring to FIG. 4, to use the present camera 1, a dental practitioner holds the handle 4 with his/her right hand 41, and inserts the head member 2 into the oral cavity 32 of a patient 31. Disposable plastic covers are provided around the head member 2 so that the head member 2 will not come into contact saliva of the patient directly, maintaining hygiene.

A dental mirror 33 is used in case the front end of the head member 2 cannot be directed at the subject position to be photographed. Referring to FIG. 4 again, the user holds the dental mirror 33 with his/her left hand for the same to be faced with the subject position to be photographed in the oral cavity, and the front end of the head member 2 is directed at the dental mirror 33 so that light from the subject is reflected to the digital camera 8 by the mirror 33. Thus, image of the subject is displayed on the monitor 3, and the image is recorded by means of pressing the button 16 with the index finger of the right hand.

The present dental camera 1 is equipped with advanced devices such as light emitting diodes, charged-coupled devices, TFT, and RAM to be relatively light in weight, and small in size. It can be easily understood that the present camera has advantages as followings:

1. The present camera with the battery 12 weights under one kilogram, allowing the user to hold and operate with one hand easily

2. The dental camera allows cost of dental practice to be reduced because the practitioner doesn't have to buy additional large-sized monitor for displaying the image to diagnose the illness or explain to the patient.

3. One dental practitioner can operate the present camera with single hand. Because the monitor 3 is disposed right behind the head member 2, the dental practitioner can check whether he has directed the head member 2 at the proper position in the patient's oral cavity by looking at the monitor 3 while he is adjusting position of the camera. Therefore, the camera is relatively convenient to use. And, the present camera can also be used in other tasks that need to make observation in narrow space such as tubing.

It is to be understood that even though characteristics of the present invention have been set forth in the foregoing description, the disclosure is illustrative only, and changes may be made without departing from the spirit and scope of this invention, such as substituting a mini camera for the digital camera.

What is claimed is:

1. A single hand held camera with a monitor for use in narrow space, comprising:
a main body, the main body having a monitor disposed on a rear side thereof for image of a subject to be displayed thereon;
a photographing member for receiving image of a subject;
a head member extending from a front side of the main body to be opposite the head member for allowing light from a subject to traveling through to be received by the photographing member; and,
a handle, the handle being joined to the main body for allowing a user to hold in operating the camera.

2. The single hand held camera with a monitor for use in narrow space as claimed in claim 1, wherein the handle has a battery disposed therein, and a memory chip inserted therein, and the handle is equipped with a button on a same side of the head member for effecting recording of image of a subject with the memory chip, and a control panel on a same side of the monitor, which is provided with a power switch, an indicator lamp, a stand-by switch, and forward and reverse play buttons to be operated for replaying images recorded in the memory chip on the monitor.

3. The single hand held camera with a monitor for use in narrow space as claimed in claim 1, wherein the head member is provided with white light emitting diodes therein for providing light to a subject to be photographed, and the photographing member is a digital camera, provided for photographing image of the subject, and the monitor is a TFT colorful display device, provided for displaying image of the subject on.

4. The single hand held camera with a monitor for use in narrow space as claimed in claim 3, wherein the head member is 0.8 to 2.5 centimeters in diameter, and 1 to 15 centimeters in length, and the digital camera has a fixed focus lens made in such a manner as to allow subjects to be photographed over a long range, and the monitor is 2.5″ to 3.5″ in size, and the camera is under 1 kg in weight.
